(19) United States
(12) Patent Application Publication
(10) Pub. No.: US 2007/0153064 A1
(43) Pub. Date: Jul. 5, 2007

(54) Liquid ejection head, liquid ejector and process for manufacturing liquid ejection head

(76) Inventors: Takaaki Miyamoto, Kanagawa (JP); Minoru Kohno, Tokyo (JP); Osamu Tateishi, Nagasaki (JP)

Correspondence Address: ROBERT J. DEPKE;LEWIS T. STEADMAN, ROCKEY, DEPKE, LYONS AND KITZINGER, LLC, SUITE 5450 SEARS TOWER, CHICAGO, IL, 60606-6306, US

(21) Appl. No.: 10/569,745

(22) PCT Filed: Aug. 19, 2004
(86) PCT No.: PCT/JP04/12240

§ 371 Date: Nov. 6, 2006

(30) Foreign Application Priority Data
Aug. 28, 2003 (JP) 2003-303856

(51) Int. Cl. B41J 2/05

(52) U.S. Cl. 347/58

(57) ABSTRACT

The present invention relates to a liquid jet head, a liquid jet apparatus, and a method of manufacturing a liquid jet head, and when applied, for example, to an ink jet printer based on the thermal system, the invention makes it possible to sufficiently secure the film thickness of a metal wiring layer concerning a wiring pattern and to reduce the parasitic resistance due to the metal wiring layer. According to the present invention, a wiring pattern 44 is formed by patterning conducted by use of dry etching, and the wiring pattern 44 is connected to heater elements 39 through contact portions 41 formed by use of openings provided in an insulating protective layer 40.

### BACKGROUND OF THE INVENTION

1. Technical Field

The present invention relates to a liquid jet head, a liquid jet apparatus, and a method of manufacturing a liquid jet head, and is applicable, for example, to a thermal type ink jet printer. In the present invention, a wiring pattern is formed through patterning by dry etching, and the wiring pattern is connected to heater elements through contact portions formed by use of openings provided in an insulating protective layer, whereby parasitic resistance due to a metal wiring layer for the wiring pattern can be reduced while sufficiently securing the film thickness of the metal wiring layer.

2. Background Art

In recent years, the need for color hard copying has been increased in the fields of image processing and the like. For meeting the need, there have been proposed color copying systems such as sublimation type thermal transfer system, melting type thermal transfer system, ink jet system, electrophotographic system and thermally developed silver salt system.

Of these systems, the ink jet system is a system in which droplets of recording liquids (inks) are jetted from nozzles provided in a printer head serving as a liquid jet head, to be deposited on an object of recording, thereby forming dots; thus, the ink jet system makes it possible to output a high-quality image while using a simple configuration. The ink jet system is classified, by the method of jetting the ink droplets from the nozzles, into the electrostatic attraction system, the continuous vibration generating system (piezo system), and the thermal system.

Of these ink jet systems, the thermal system is a system in which a bubble is generated by local heating of an ink, and the ink is pushed by the bubble out through a nozzle, to be jetted onto an object of printing; thus, the thermal system makes it possible to print a color image while using a simple configuration.

A printer head based on such a thermal system has a configuration in which heater elements for heating inks are formed on a semiconductor substrate, together with a drive circuit based on a logic integrated circuit for driving the heater elements. In this kind of printer head, the heater elements are arranged in a high density, and it is contrived that the heater elements can be driven assuredly.

In the printer of the thermal system, for obtaining a high-quality print, it is necessary to arrange the heater elements in a high density. Specifically, for obtaining a print equivalent to 600 DPI, for example, it is necessary to arrange the heater elements at an interval of 42.333 μm, and it is extremely difficult to arrange individual driving elements for the heater elements which are arranged in such a high density. In the printer head, therefore, switching transistors or the like are formed on a semiconductor substrate, they are connected to the corresponding heater elements by an integrated circuit technology, and they are driven by a drive circuit similarly formed on a semiconductor substrate, whereby the heater elements can be driven easily and assuredly.

In addition, in the printer based on the thermal system, a bubble is generated in the ink by impressing a predetermined electric power on the heater element, and the bubble is distinguished upon jetting of the ink droplet out through the nozzle. Each time the bubbling and debubbling are repeated, a mechanical shock due to cavitation is exerted. In the printer, furthermore, a temperature rise due to heat generation by the heater elements and a temperature fall are repeated in a short time (a few microseconds), whereby a large stress due to the temperature variation is exerted.

Therefore, in the printer head, the heater elements are formed on the semiconductor substrate, and an insulating protective layer is formed on the heater elements so that the heater elements are protected from the ink by the insulating protective layer. Further, a metal protective layer is formed on the insulating protective layer; the metal protective layer relaxes the thermal shock due to the cavitation, and suppresses chemical reactions of ink components at the time when the heat is transferred from the heater element to the ink. Thus, in the printer head, the insulating protective layer and the metal protective layer function to protect the heater elements and to secure reliability.

When the film thicknesses of the insulating protective layer and the metal protective layer are increased in the printer head, the reliability can be enhanced, but it becomes impossible to efficiently transfer the heat of the heater element to the ink. In view of this, in the printer head, the materials constituting the insulating protective layer and the metal protective layer and the film thicknesses of the constituent materials are set according to the resistance and shape of the heater elements, then, for the printer head configured based on these settings, the heater elements are driven under various conditions so as to determine the conditions suitable for stable jetting of the inks and the like, and driving conditions for the heater elements are set within the ranges of the conditions thus determined.

To be more specific, for example in Japanese Patent Laid-open No. 2001-80077, there is proposed a method in which the film thickness of an insulating protective layer composed of a silicon nitride film and a silicon carbide film is set in the range of 355 to 435 nm and heat elements are driven at 1.0 to 1.4 μJ by a driving signal having a rectangular waveform. Besides, in Japanese Patent Laid-open Nos. 2001-130003 and 2001-130005, there is proposed a method in which the film thickness of an insulating protective layer composed of a silicon nitride film is set in the range of 260 to 340 nm, the total film thickness of the insulating protective layer and a metal protective layer is set to be not more than 630 nm, and heater elements are driven by a driving signal with a width of not more than 1.2 μs.

The printer heads thus configured are of the so-called face shooter type in which an ink droplet is pushed out through a nozzle provided on a heater element by the pressure of a bubble. Conventionally, a wiring pattern composed of a metal wiring layer for connecting semiconductor devices to heater elements is formed through pattering a laminated wiring pattern material by a dry etching step and a wet etching step.

Specifically, this kind of printer head 1, as shown in FIG. 1A, is formed by a method in which an insulating layer (SiO₂) or the like is laminated on a semiconductor substrate 2 provided with semiconductor devices, and then heater elements 3 are formed. Subsequently, as shown in FIG. 1B, a wiring pattern material layer 4 of aluminum or the like is built up, and the wiring pattern material layer 4 is processed by a dry etching step, to form a wiring pattern 5.

In this instance, in the printer head 1, the wiring pattern 5 is so formed as to leave the wiring pattern material layer 4 on the heater elements 3. Subsequently, in the printer head 1, as shown in FIG. 1C, a photoresist layer 6 is so formed that the portion left on the heater elements 3 can be etched, and the wiring pattern material 4 left on the heater elements 3 is removed by a wet etching step using a liquid chemical containing phosphoric acid and nitric acid as main components. By this, as shown in FIG. 1D, the wiring pattern 5 and the heater elements 3 overlap each other and the heater elements 3 are connected to the wiring pattern 5 at end portions of the heater elements 3, and, further, the heater elements 3 are connected to semiconductor devices and the like for driving the heater elements 3, through the wiring pattern 5.

In this instance, in the printer head 1, the overlapping of the heater elements 3 and the wiring pattern 5 generates steps in the surface, but end portions of the wiring pattern 5 as wall surfaces of the steps are etched in a tapered form, whereby the step coverage of an insulating protective layer 7 and a metal protective layer 8 sequentially formed thereafter at the wall surface portions is enhanced.

Subsequently, as shown in FIG. 1E, the insulating protective layer 7 of silicon nitride (Si₃N₄) or the insulating protective layer 7 of silicon nitride and silicon carbide is formed, and the metal protective layer 8 of β-tantalum having a tetragonal system structure is formed thereon. In the printer head 1, then, predetermined members are disposed, to form ink liquid chambers, ink passages and nozzles.

In forming the wiring pattern by the dry etching step and the wet etching step, if the film thickness of the wiring pattern 5 is large, as the area surrounded by symbol A in FIG. 1 is enlargedly shown in FIG. 2, the wiring pattern 5 is locally rugged in the wet etching step for exposing the heater element 3. In the example shown in FIG. 2, the wiring pattern 5 is formed with a film thickness of about 0.5 μm.

Specifically, the wet etching using the liquid chemical can selectively pattern only the wiring pattern material layer 4 while preventing damage to the surface of the heater element 3. When the film thickness of the wiring pattern 5 to be processed is large, however, the wall surface portions forming the steps are etched unevenly, whereby the wiring pattern 5 in the printer head 1 is rugged at the wall surface portions. In the printer head 1, when the wiring pattern 5 is thus rugged, the insulating protective layer 7 and the metal protective layer 8 are sequentially formed uniformly along the rugged shape of the wiring pattern 5, so that, as indicated by arrow B, voids are generated at the interface between the insulating protective layer 7 and the wiring pattern 5, whereby reliability is deteriorated.

To cope with this problem, for example in Japanese Patent Laid-open No. 2001-130003, there is proposed a method in which the film thickness of the wiring pattern is set within the range of 0.18 to 0.24 μm so as to accurately form the wall surface portions. In the printer head 1, when the film thickness of the wiring pattern is set small by applying this technique, as shown in FIG. 3 in contrast to FIG. 2, the wall surface portions can be formed accurately; however, weakening of the wiring pattern 5 becomes conspicuous, and the resistance of the wring pattern 5 is raised. Specifically, for example in Japanese Patent Laid-open No. 2002-355971, in the case where the film thickness of the wiring pattern 5 is set at 0.2 μm, the measurement of the resistance of the wiring pattern 5 and the total parasitic resistance including the resistance of the wiring pattern 5 and the ON resistance of the transistor showed that the resistance of the wiring pattern 5 was 8Ω and the parasitic resistance was 25Ω. Thus, in this case, the parasitic resistance is about ⅓ based on the resistance of the whole portion served to drive the heater element 3 inclusive of the resistance 53Ω of the heater element 3. Accordingly, in applying the technique disclosed in Japanese Patent Laid-open Nos. 2001-130003 and 2002-355971, the loss in the power served to drive the heater element 3 is increased due to the wiring resistance, whereby the driving power for the heater element 3 concerning the jetting of the ink droplet is increased.

Besides, in the conventional wiring pattern forming step, the dry etching step using an etching gas and the wet etching step using a liquid chemical must be used in combination, which takes a correspondingly additional time in manufacturing the printer head. Incidentally, this problem is pointed out also in Japanese Patent Laid-open No. 2002-79679.

As a method of solving this problem, for example in Japanese Patent Laid-open No. 2000-108355, a method is proposed in which the wiring pattern is formed through an etching treatment using only a dry etching step. However, the printer head produced by this technique is of the so-called edge shooter type in which a pressure wave due to the pressure of a bubble is propagated to push an ink droplet out through a nozzle formed at other portion than the portion directly above the heater element, and the heater element is formed of polycrystalline silicon, so that there arises no problem even if steps of about 2 to 3 μm due to the insulating protective layer and the metal protective layer are generated on the heater element. On the other hand, in the face shooter type printer head, when the printer head is produced by this technique and such severe steps are generated, the heat of the heater element cannot be efficiently transferred to the ink, so that there are still unsatisfactory points on a practical basis in applying the technique disclosed in Japanese Patent Laid-open No. 2000-108355.

### DISCLOSURE OF INVENTION

The present invention has been made in consideration of the above-mentioned points. Accordingly, it is an object of the present invention to provide a liquid jet head, a liquid jet apparatus and a method of manufacturing a liquid jet head such that the film thickness of a metal wiring layer concerning a wiring pattern can be secured sufficiently and to reduce the parasitic resistance due to the metal wiring layer.

In order to attain the above object, according to an aspect of the present invention, there is provided a liquid jet head including a heater element for heating a liquid retained in a liquid chamber, and a semiconductor device for driving the heater element, the heater element and the semiconductor device being integrally held on a predetermined substrate, and a droplet of the liquid being jetted from a predetermined nozzle by driving the heater element, wherein an insulating protective layer for protecting the heater element from the liquid and a metal wiring layer for connecting the semiconductor device to the heater element are sequentially disposed on the liquid chamber side of the heater element; and the metal wiring layer is connected to the heater element through a contact portion formed by use of an opening provided in the insulating protective layer, and is formed through patterning by dry etching with an etching gas.

By this configuration according to the present invention, in a liquid jet head including a heater element for heating the liquid retained in a liquid chamber, and a semiconductor device for driving the heater element, the heater element and the semiconductor device being integrally held on a predetermined substrate, and a droplet of the liquid being jetted from a predetermined nozzle by driving the heater element, an insulating protective layer for protecting the heater element from the liquid and a metal wiring layer for connecting the semiconductor device to the heater element are sequentially disposed on the liquid chamber side of the heater element; and the metal wiring layer is connected to the heater element through a contact portion formed by use of an opening provided in the insulating protective layer, and is formed through patterning by dry etching with an etching gas, whereby damage to the heater element by the etching gas is prevented, and wall surfaces of steps arising from the metal wiring layer are formed accurately. This makes it possible to sufficiently secure the film thickness of the metal wiring layer concerning the wiring pattern and to reduce the parasitic resistance due to the metal wiring layer.

According to another aspect of the present invention, there is provided a liquid jet apparatus for jetting a droplet by driving a heater element provided in a liquid jet head, wherein the liquid jet head includes the heater element for heating a liquid retained in a liquid chamber, and a semiconductor device for driving the heater element, the heater element and the semiconductor device being integrally held on a predetermined substrate; an insulating protective layer for protecting the heater element from the liquid and a metal wiring layer for connecting the semiconductor device to the heater element are sequentially disposed on the liquid chamber side of the heater element; and the metal wiring layer is connected to the heater element through a contact portion formed by use of an opening provided in the insulating protective layer, and is formed through patterning by dry etching with an etching gas.

By this configuration according to the present invention, there can be provided a liquid jet apparatus such that the film thickness of the metal wiring layer concerning the wiring pattern is sufficiently secured, and the parasitic resistance due to the metal wiring layer can be reduced.

According to a further aspect of the present invention, there is provided a method of manufacturing a liquid jet head including a heater element for heating a liquid retained in a liquid chamber, and a semiconductor device for driving the heater element, the heater element and the semiconductor device being integrally held on a predetermined substrate, and a droplet of the liquid being jetted from a predetermined nozzle by driving the heater element, wherein an insulating protective layer for protecting the heater element from the liquid and a metal wiring layer for connecting the semiconductor device to the heater element are sequentially disposed on the liquid chamber side of the heater element, and the metal wiring layer is connected to the heater element through a contact portion formed by use of an opening provided in the insulating protective layer, and is formed through patterning by dry etching with an etching gas.

By this configuration according to the present invention, there can be provided a method of manufacturing a liquid jet head such that the film thickness of the metal wiring layer concerning the wiring pattern can be sufficiently secured, and the parasitic resistance due to the metal wiring layer can be reduced.

According to the present invention, it is possible to sufficiently secure the film thickness of a metal wiring layer concerning a wiring pattern and to reduce the parasitic resistance due to the metal wiring layer.

### BRIEF DESCRIPTION OF DRAWINGS

FIGS. 1A, 1B, 1C, 1D and 1E are sectional views served to illustration of the formation of a printer head according to the related art.

FIG. 2 is a sectional view served to illustration of patterning of a wiring pattern in the printer head shown in FIGS. 1A to 1E.

FIG. 3 is a sectional view showing another example of the patterning of the wiring pattern.

FIG. 4 is a perspective view of a printer according to Embodiment 1 of the present invention.

FIG. 5 is a plan view showing the arrangement configuration of head chips in the printer head shown in FIG. 4.

FIG. 6 is a sectional view showing the printer head shown in FIG. 4.

FIGS. 7A and 7B are sectional views for illustrating the steps of producing the printer head shown in FIG. 6.

FIGS. 8A and 8B are sectional views showing the steps subsequent to FIG. 7B.

FIGS. 9A and 9B are sectional views showing the steps subsequent to FIG. 8B.

FIG. 10 is a sectional view showing the step subsequent to FIG. 9B.

FIG. 11 is a sectional view showing the step subsequent to FIG. 10.

FIG. 12 is a characteristic curve diagram served to description of ink jet speed in the printer head shown in FIG. 6.

FIGS. 13A, 13B, 13C and 13D are sectional views served to illustration of the formation of a wiring pattern.

FIGS. 14A, 14B, 14C and 14D are sectional views served to illustration of the steps for producing a printer head applied to a printer according to Embodiment 2 of the present invention.

### BEST MODE FOR CARRYING OUT THE INVENTION

Now, embodiments of the present invention will be described in detail below referring appropriately to the drawings.

### (1) Configuration of Embodiment

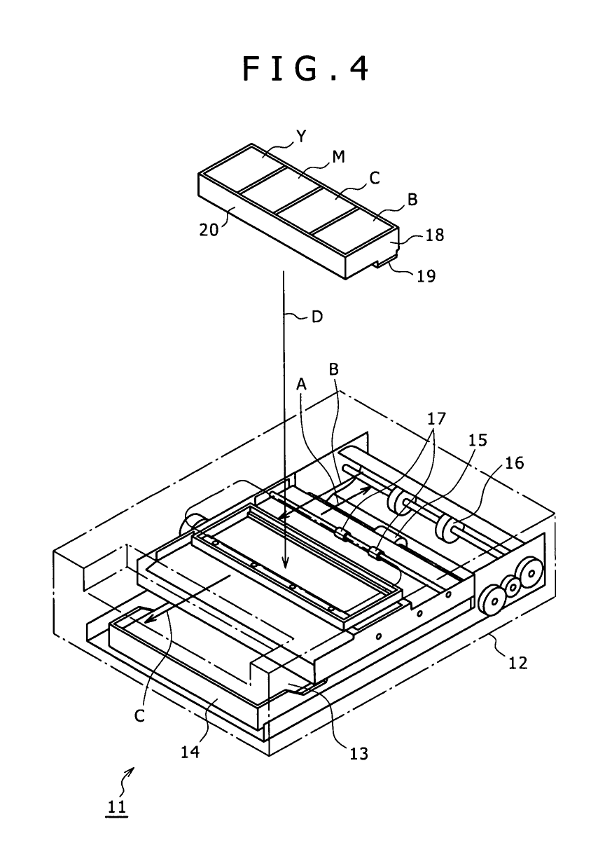

FIG. 4 is a perspective view showing a printer according to Embodiment 1 of the present invention. The line printer 11 is entirely contained in a rectangular casing 12, and a paper tray 14 containing therein papers 13 as objects of printing is mounted via a tray inlet/outlet formed on the front side of the casing 12, whereby the papers 13 can be fed.

When the paper tray 14 is mounted into the line printer 11 via the tray inlet/outlet, the papers 13 is pushed against a paper fed roller 15 by a predetermined mechanism, and, when the paper feed roller 15 is rotated, the paper 13 is fed out from the paper tray 14 toward the back side of the line printer 11, as indicated by arrow A. The line printer 11 has a reversing roller 16 disposed on the paper feeding side, and, by the rotation of the reversing roller 16 and the like, the feed direction of the paper 13 is changed over to the front direction, as indicated by arrow B.

In the line printer 11, the paper 13 for which the paper feed direction is changed over to the direction of arrow B is fed so as to cross the paper tray 14 on the upper side of the paper tray 14 by a spur roller 17 and the like, and the paper is discharged through a discharge port disposed on the front side of the line printer 11. The line printer 11 has a head cartridge 18 replaceably disposed in the range from the spur roller 17 to the discharge port, as indicated by arrow D.

The head cartridge 18 has a configuration in which a printer head 19 including yellow, magenta, cyan and black line heads in an array is disposed on the lower side of a holder 20 having a predetermined shape, and yellow (Y), magenta (M), cyan (C) and black (B) ink cartridges are replaceably arranged sequentially in the holder 20. The line printer 11 is so configured that inks are deposited onto the paper 13 from the line heads corresponding to the color inks, whereby an image can be printed.

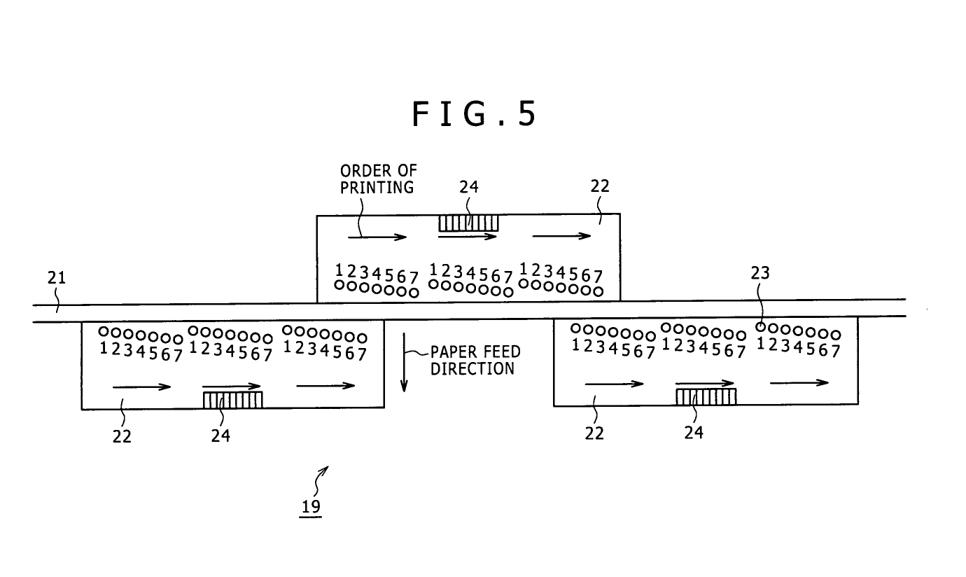

Here, FIG. 5 is a plan view showing enlargedly a part of the arrangement configuration of the printer head as viewed from the side of the paper 13 in FIG. 4. As shown in FIG. 5, the printer head 19 has a configuration in which head chips 22 having the same configuration are disposed alternately (in a zigzag pattern) on a nozzle plate on both sides of an ink passage 21 for each color ink. In each head chip 22, heater elements are disposed on the ink passage 21 side; namely, the head chips 22 on both sides are turned in sense by 180 degrees, with the ink passage 21 side therebetween. In the printer head 19, therefore, each head chip 22 can be supplied with the ink through the single system of ink passage 21 for each color, and, accordingly, the resolution of printing accuracy can be enhanced with a simple configuration.

In addition, in the head chip 22, a connection pad 24 is disposed substantially at the center in the array direction of nozzles 23 which are minute ink jet ports (in the printing width direction) so that the position of the connection pad 24 is not changed in the array direction of the nozzles 23 even when the head chip 22 is disposed by turning by 180 degrees. This configuration ensures that flexible wiring boards to be connected to the connection pads 24 of the adjacent head chips 22 in the printer head 19 are prevented from becoming close to each other; in other words, the flexible wiring boards are prevented from being concentrated into a part.

Incidentally, where the nozzles 23 are shifted in this manner, the order of driving of the heater elements in response to driving signals are reversed, in the head chip 22 disposed on the upper side of the ink passage 21 and in the head chip 22 disposed on the lower side of the ink passage 21. Each head chip 22 is so configured that the order of driving in a drive circuit can be changed over so as to correspond to the orders of driving.

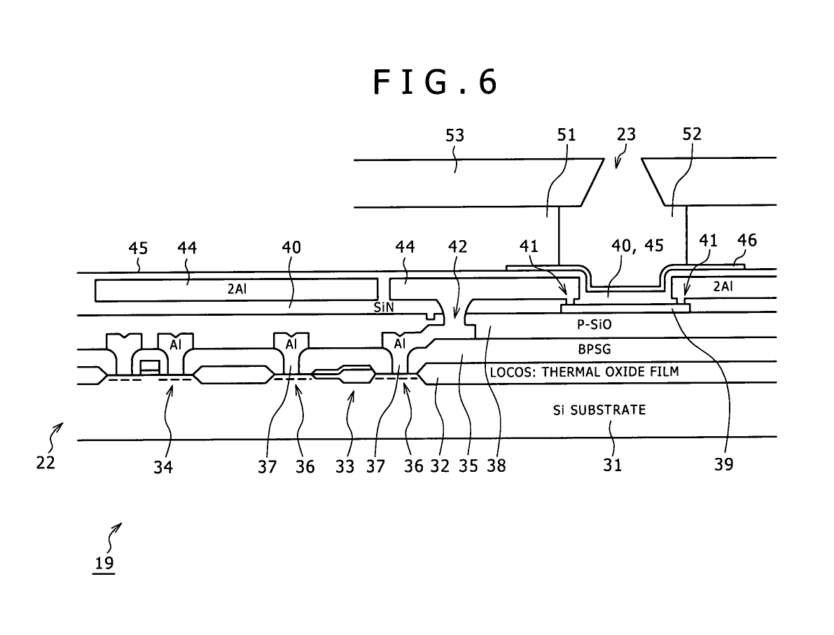

FIG. 6 is a sectional view showing a printer head applied to the line printer. The printer head 19 is produced by a method in which drive circuits, heater elements and the like for a plurality of heads are formed on a wafer of a silicon substrate, and each head chip 22 is subjected to a scribing treatment so as to provide the head chip 22 with ink liquid chambers and the like.

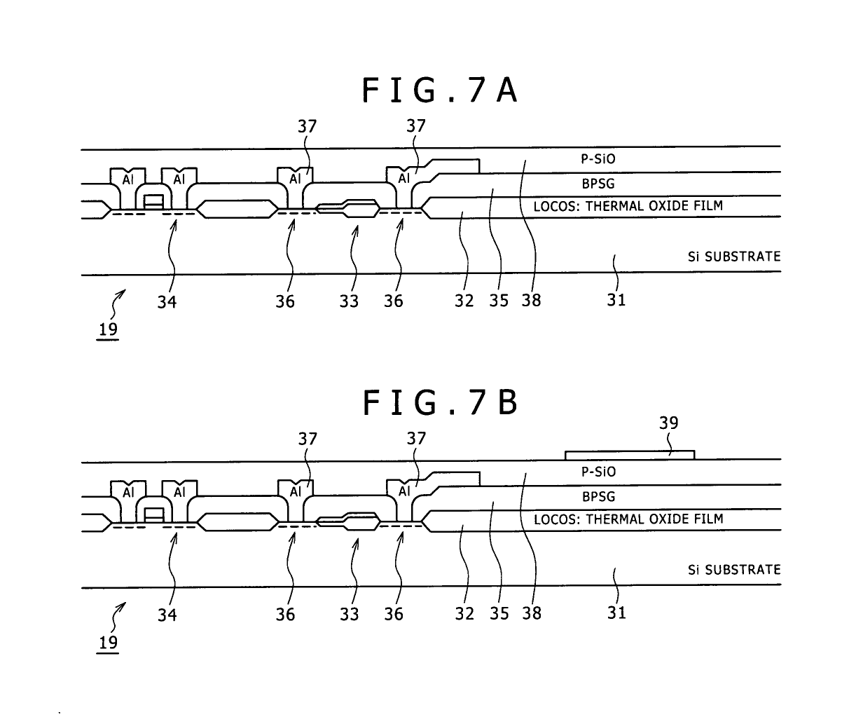

Specifically, as shown in FIG. 7A, in the printer head 19, after the silicon substrate 31 of the wafer is cleaned, a silicon nitride film (Si₃N₄) is built up. Subsequently, in the printer head 19, the silicon substrate 31 is treated by a photolithography step and a reactive ion etching step, whereby the silicon nitride film is removed from the other regions than predetermined region where transistors are to be formed. By these steps, in the printer head 19, the silicon nitride film is formed in the regions where the transistors are to be formed on the silicon substrate 31.

Subsequently, in the printer head 19, a thermal silicon oxide film is formed by a thermal oxidization step in a thickness of 500 nm in the regions where the silicon nitride film has been removed, and device isolation regions (LOCOS: Local Oxidation Of Silicon) 32 for isolating the transistors are formed from the thermal oxide film. Incidentally, the device isolation regions 32 are formed finally to have a film thickness of 260 nm by a later treatment. Subsequently, in the printer head 19, the silicon substrate 31 is cleaned, and thereafter gates of a tungsten silicide/polysilicon/thermal oxide film structure are formed in the transistor forming regions. Further, the silicon substrate 31 is treated by an ion implantation step and a thermal treatment step for forming source/drain regions, to form MOS (Metal-Oxide-Semiconductor) type transistors 33 and 34 and the like. Here, the switching transistor 33 is a MOS type driver transistor having a withstand voltage of about 25 V, and is used for driving the heater element. On the other hand, the switching transistor 34 is a transistor for constituting an integrated circuit for controlling the driver transistor, and is operated at a voltage of 5 V. Incidentally, in this embodiment, a low-concentration diffusion layer is formed between the gate and the drain, so as to moderate the electric field of electrons accelerated at the portion, thereby forming the driver transistor 33 while securing the withstand voltage.

When the transistors 33 and 34 as semiconductor devices are formed on the silicon substrate 31, in the printer head 19, a PSG (Phosphorus Silicate Glass) film which is a silicon oxide film with phosphorus added thereto and a BPSG (Boron Phosphorus Silicate Glass) film 35 with boron and phosphorus added thereto are sequentially formed in respective thicknesses of 100 nm and 500 nm by CVD (Chemical Vapor Deposition), whereby a first layer insulation film with a total film thickness of 600 nm is formed.

Subsequently, a photolithography step is conducted, and then contact holes 36 are formed on the silicon semiconductor diffusion layer (source/drain) by a reactive ion etching process using a C₄F₈/CO/O₂/Ar based gas.

Further, in the printer head 19, cleaning with diluted hydrofluoric acid is conducted, and then a 30 nm thick titanium film, a 70 nm thick titanium oxynitride barrier metal film, a 30 nm thick titanium layer, and a 500 nm thick film of aluminum with 1 at % of silicon added thereto or of aluminum with 0.5 at % of copper added thereto are sequentially built up by sputtering. Subsequently, in the printer head 19, a titanium oxynitride film as anti-reflection film is built up in a thickness of 25 nm, and a film of a wiring pattern material is formed by these films. Furthermore, in the printer head 19, the film of the wiring pattern material is selectively removed by a photolithography step and a dry etching step, whereby a first-layer wiring pattern 37 composed of a metal wiring layer of aluminum with silicon or copper added thereto is formed. In the printer head 19, by the first-layer wiring pattern 37 thus formed, the MOS type transistors 34 constituting the drive circuits are connected to form a logic integrated circuit.

Subsequently, in the printer head 19, a silicon oxide film as a layer insulation film is built up by a CVD process using TEOS (tetraethoxysilane: Si(OC₂H₅)₄). Subsequently, in the printer head 19, application of a coating type silicon oxide film containing SOG (Spin On Glass) and etch-back are conducted to flatten the silicon oxide film, and these steps are repeated twice, to form a second layer insulation film (P—SiO) 38 composed of 440 nm thick silicon oxide film for insulation between the first-layer wiring pattern 37 and a second-layer wiring pattern to be formed followingly.

Subsequently, as shown in FIG. 7B, the printer head 19 is mounted in a sputter film forming chamber of a sputtering apparatus, a β-tantalum film is built up in a thickness of 50 to 100 nm by sputtering, to form a resistance film on the silicon substrate 31. In this case, the substrate temperature was set at 200 to 400° C., the DC power was set at 2 to 4 kW, and the argon flow rate was set at 25 to 40 sccm.

Subsequently, in the printer head 19, the resistance film was selectively removed in a square shape or in a turn-back form with connection at one end thereof through the wiring pattern by a photolithography step and a dry etching step using a BCl₃/Cl₂ gas, whereby heater elements 39 having a resistance of 40 to 100Ω are formed. Incidentally, in this embodiment, a 83 nm thick resistance film is built up, and the heater elements 39 in the turn-back shape are formed so that the heater elements 39 each have a resistance of 100Ω.

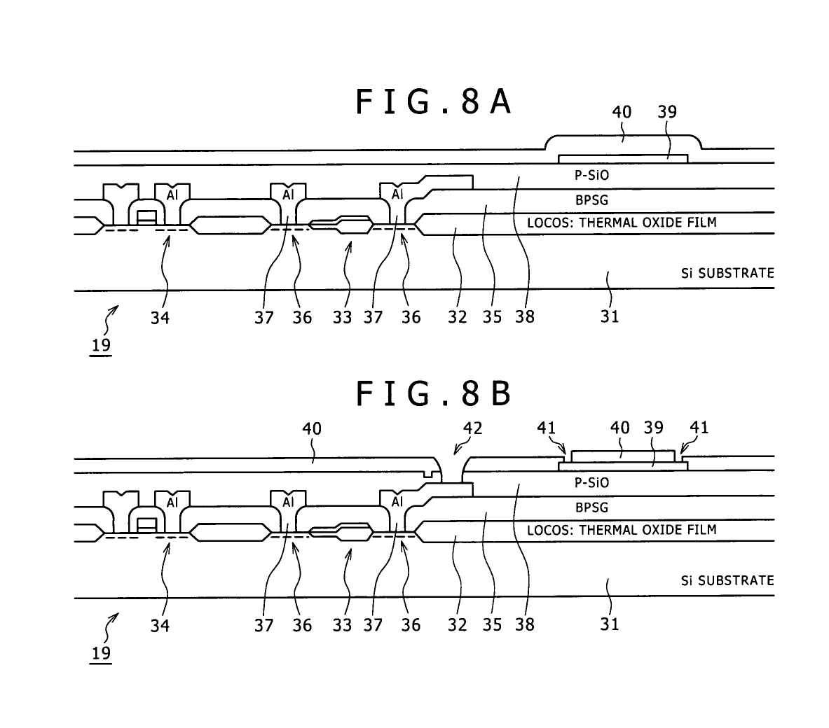

When the heater elements 39 are formed in this manner, in the printer head 19, as shown in FIG. 8A, a 300 nm thick silicon nitride film is built up by CVD, to form an insulating protective film 40 for the heater elements 39.

Subsequently, in the printer head 19, as shown in FIG. 8B, the silicon nitride film 40 in predetermined areas is removed by a photoresist step and a dry etching step using a CHF₃/CF₄/Ar gas, whereby openings are formed in the insulating protective film 40, and contact portions 41 are formed. Further, by a dry etching step using a CHF₃/CF₄/Ar gas, openings are formed in the layer insulation film 38, to form via holes 42. Here, the contact portions 41 are contact portions provided in the preceding step of a second-layer wiring pattern for connecting the second-layer wiring pattern to the underlying heater elements 39, and the via holes 42 are contact portions provided in the preceding step of the second-layer wiring pattern for connecting the second-layer wiring pattern to the underlying first-layer wiring pattern 37.

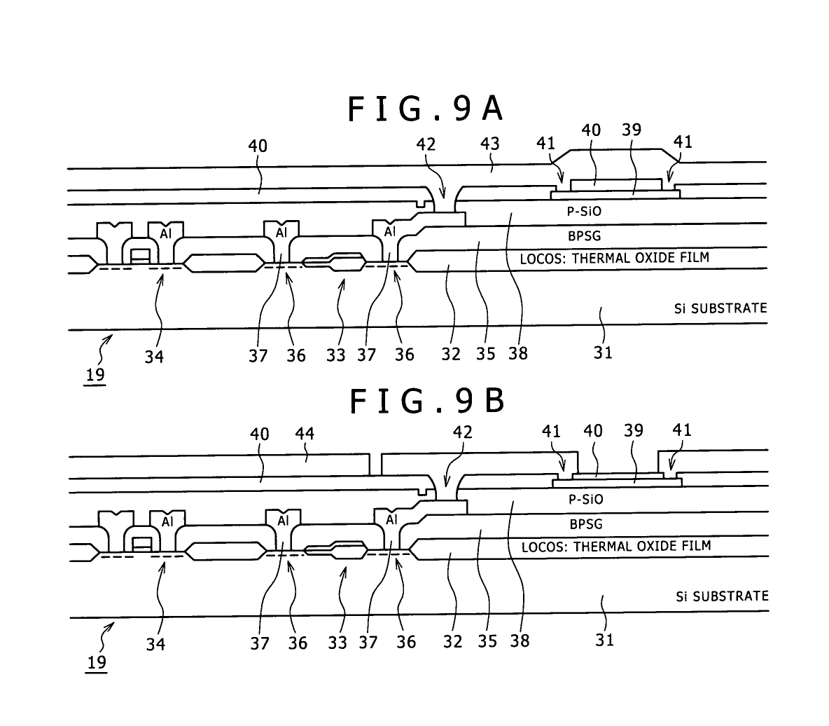

In the printer head 19, when the contact portions 41 and the via holes 42 are thus formed, a wiring pattern material layer 43 is formed by use of a metal wiring layer of aluminum with silicon or copper added thereto or the like, as shown in FIG. 9A, and surplus portions of the wiring pattern material layer 43 is removed, as shown in FIG. 9B, whereby the second-layer wiring pattern 44 is patterned.

Here, in this embodiment, the film thickness of the metal wiring layer of the wiring pattern material layer 43 is set to be not less than 400 nm. Therefore, in the patterning of the wiring pattern 44, at the time of dry etching the wiring pattern material layer 43 in other areas than the areas on the upper side of the heater elements 39 by an etching gas containing a chlorine atom component, the wiring pattern material layer 43 on the upper side of the heater elements 39 is simultaneously removed.

Specifically, the dry etching gas conducted using the etching gas containing the chlorine atom component is a method in which a chlorine-based gas is excited to form a plasma stream containing chlorine radical species, and the work is irradiated with the plasma stream, whereby the work is reduced and removed by the chlorine radical species in the plasma, and is an anisotropic etching in which the work is etched in a direction substantially perpendicular to the substrate.

By this dry etching, the wiring pattern material layer 43 on the upper side of the heater elements 39 is removed by the chlorine radical species in the plasma, whereby in the printer head 19, wall surfaces constituting steps generated in the wiring pattern 44 are formed accurately, and generation of voids at the interface between the wiring pattern 44 and an insulating protective film to be formed thereon later is prevented.

Besides, in the printer head 19, the wiring pattern material layer 43 on the heater elements 39 is thus removed, whereby the insulating protective layer 40 concerning the formation of the contact portions 41 is exposed. By this, in the printer head 19, the insulating protective layer 40 is exposed to the plasma stream containing the chlorine radical species, and is etched by the chlorine radical species in the plasma; however, the insulating protective layer 40 functions as a mask for the heater elements 39, so that the heater elements 39 are not exposed directly to the plasma stream containing the chlorine radical species, and etching of the surfaces of the heater elements 39 is prevented. Thus, in the printer head 19, the previously formed insulating protective layer 40 served to the formation of the contact portions 41 prevents the heater elements 39 from being damaged by the dry etching.

Specifically, in the printer head 19, a 200 nm thick film of titanium and a 600 nm thick film of aluminum with 1 at % silicon added thereto or of aluminum with 0.5 at % of copper added thereto are sequentially built up by sputtering. Subsequently, in the printer head 19, a 25 nm thick film of titanium oxynitride is built up, to form an anti-reflection film. By these steps, in the printer head 19, the wiring pattern material layer 43 composed of the metal wiring layer of aluminum with silicon or copper added thereto is formed.

Subsequently, in the printer head 19, the wiring pattern material layer 43 is selectively removed by a photolithography step and a dry etching step using a BCl₃/Cl₂ gas, to form the second-layer wiring pattern 44. Incidentally, in this embodiment, for over-etching, the dry etching step is conducted for an etching time set to be about 1.2 times the etching time corresponding to the film thickness of the wiring pattern material layer 43, whereby the surplus wiring pattern material layer 43 is removed securely, and short-circuiting between the wiring patterns due to the leaving of the wiring pattern material layer is prevented satisfactorily. As a result of the dry etching, the 300 nm thick silicon nitride film 40 previously formed on the heater elements 39 was etched by an amount of 200 nm film thickness, to be 100 nm in film thickness.

In the printer head 19, the metal wiring layer concerning the wiring pattern 44 is formed in a film thickness of 600 nm, whereby weakening of the metal wiring layer itself is prevented, and the resistance of the metal wiring layer is prevented from being raised.

Specifically, upon measurement of the resistance of the metal wiring layer and the parasitic resistance inclusive of the ON resistance of the transistor 34, it was found that the resistance of the metal wiring layer was 1.5Ω, and the parasitic resistance inclusive of the ON resistance of the transistor 34 was 12Ω. By this, in the printer head 19, the parasitic resistance relative to the whole resistance obtained by adding the resistance 100Ω of the heater element 39 becomes about 1/9, showing that the parasitic resistance can be reduced as compared with that in the related art. More specifically, in comparison with the printer head described referring to FIG. 3, the ratio of the parasitic resistance to the whole resistance can be reduced by about ⅔.

Besides, in the dry etching of the wiring pattern 44, the wiring pattern material layer 43 on the heater elements 39 is simultaneously removed by the dry etching step using the etching gas, whereby the number of steps is reduced and the time taken for manufacturing the printer head 19 is shortened, as compared with the related art.

In the printer head 19, by the second-layer wiring pattern 44 thus formed, a wiring pattern for a power supply and a wiring pattern for earth are formed, and a wiring pattern for connecting the driver transistors 34 to the heater elements 39 through the contact portions 41 and the via holes 42 is formed.

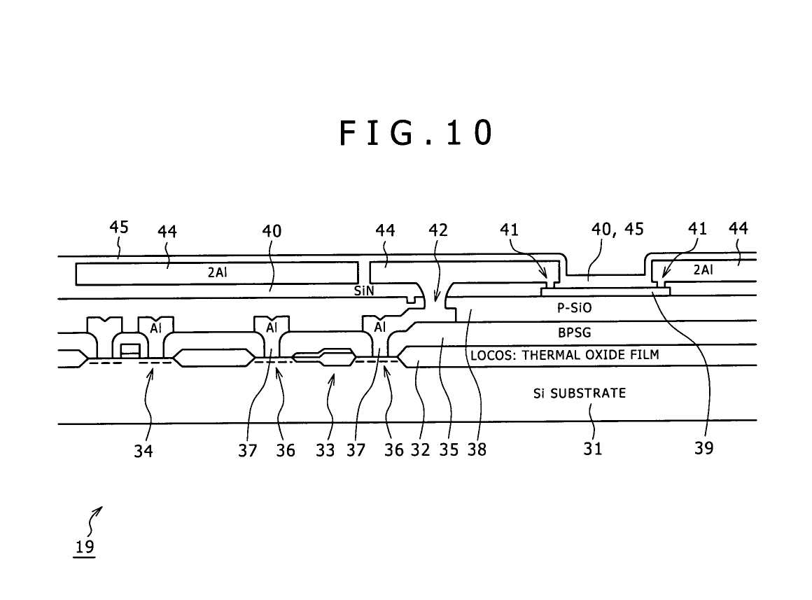

Subsequently, in the printer head 19, as shown in FIG. 10, a 200 to 400 nm thick silicon nitride film 45 as an insulating protective layer is built up by plasma CVD. Further, in a heat treating furnace, a heat treatment at 400° C. for 60 min is conducted in an atmosphere of nitrogen gas with 4% hydrogen added thereto or in a 100% nitrogen atmosphere. By this, the operations of the transistors 33 and 34 in the printer head 19 are stabilized, the connection between the first-layer wiring pattern 37 and the second-layer wiring pattern 44 is stabilized, and contact resistance is reduced.

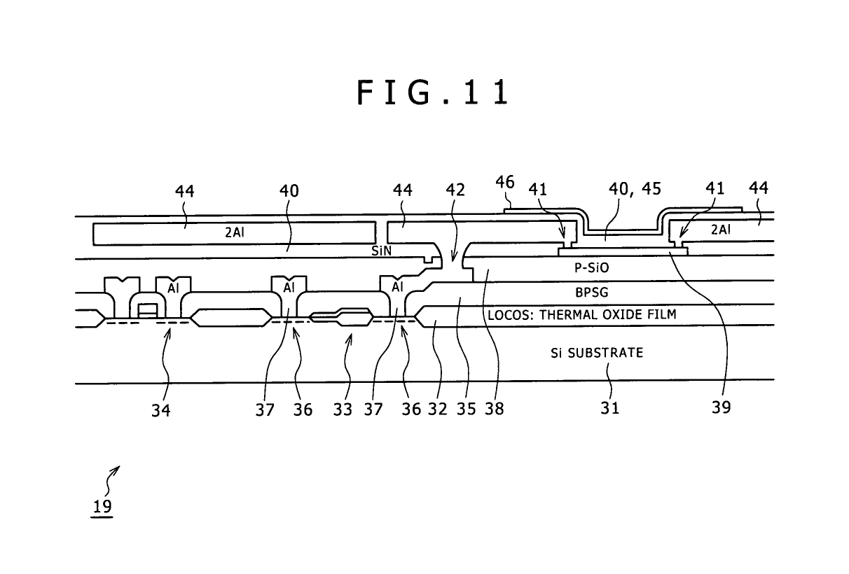

Subsequently, as shown in FIG. 11, the printer head 19 is mounted in a sputter film forming chamber in a DC magnetron sputtering apparatus, and a metal protective layer material film of β-tantalum is built up in a thickness of 100 to 300 nm by sputtering. Subsequently, in the printer head 19, the metal protective layer material film is masked in a desired shape by a photoresist step, and an etching treatment with this mask is conducted by a dry etching step using a BCl₃/Cl₂ gas, to form a metal protective layer 46. Incidentally, to the formation of the metal protective layer 46, tantalum-aluminum (TaAl) with an aluminum content set to about 15 at % may be applied. Incidentally, the tantalum-aluminum with the aluminum content of about 15 at % has a structure in which aluminum is preset at the β-tantalum crystal grin boundaries, and film stress can be reduced as compared with the case of forming the metal protective layer from β-tantalum.

In the printer head 19, a silicon nitride film 45 is built up on the silicon nitride film 40 thinned by the dry etching of the wiring pattern 44, whereby the insulating protective layer is composed of the silicon nitride films 40 and 45, and a metal protective layer 46 is further formed thereon. In the printer head 19, the heater elements 39 are protected by the insulating protective layer 40, 45 and the metal protective layer 46 to thereby secure the reliability; in this embodiment, the total thickness of the insulating protective layer 40, 45 and the metal protective layer 46 is set to be not more than 700 nm.

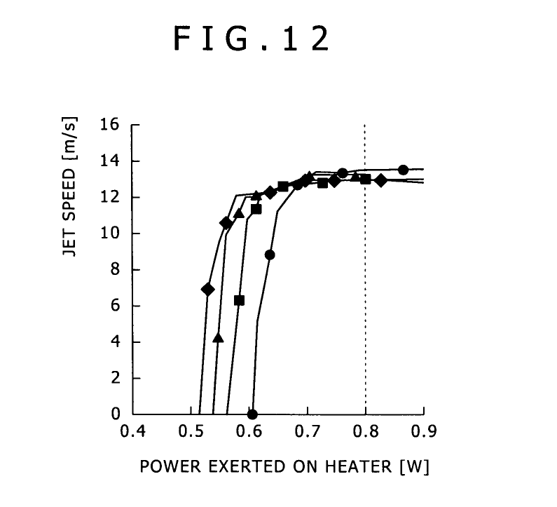

The measurement results shown in FIG. 12 show the jet speed of ink droplets jetted out through nozzles by driving the heater elements by various values of driving power, in printer heads in which the metal protective layer is formed in a film thickness of 200 nm and the film thickness of the insulating protective layer are varied under the condition where the total film thickness of the insulating protective layer and the metal protective layer is not more than 700 nm. Incidentally, in FIG. 12, the solid circles indicate a printer head with a 500 nm thick insulating protective layer, solid squares indicate a printer head with a 400 nm thick insulating protective layer, solid triangles indicate a printer head with a 350 nm thick insulating protective layer, and solid rhombuses indicate a printer head with a 300 nm thick insulating protective layer.

From the measurement results, it is confirmed that a reduction in the film thickness of the insulating protective layer lowers the driving power at which the jetting of ink droplets is started. In addition, as indicated by the broken line, it was confirmed that, in the case of driving the heater elements by a rated driving power of 0.8 W, stable ink jetting is achieved with sufficient margin in every one of the printer heads. Incidentally, in this embodiment, the insulating protective layer 40, 45 and the metal protective layer 46 are 500 nm and 200 nm in film thickness, and the heat of the heater elements 39 can be efficiently transferred to the ink.

Subsequently, in the printer head 19, as shown in FIG. 6, a dry film 51 made of an organic resin is disposed by press bonding, its portions corresponding to ink liquid chambers 52 and ink passages are removed, and the resin is then cured, to form partition walls of the ink liquid chambers 52, partition walls of the ink passages 21 and the like.

Subsequently, after scribing for separation into head chips 22, a nozzle plate 53 is laminated. Here, the nozzle plate 53 is a plate-like member processed into a predetermined shape so as to form the nozzles 23 on the upper side of the heater elements 39, and is held onto the dry film 51 by adhesion. By this, the printer head 19 is provided with the nozzles 23, the ink liquid chambers 52, the ink passages 21 for leading the ink into the ink liquid chambers 52, and the like.

The printer head 19 is so produced that the ink liquid chambers 52 are formed to be continuous in the depth direction of the paper surface, to thereby constitute the line head.

### (2) Operations of Embodiment

With the above configuration, in the printer head 19, the device isolation regions 32 are formed in the silicon substrate serving as the semiconductor substrate, the transistors 33 and 34 as semiconductor devices are formed, insulation by the insulating layer 35 is conducted, and the first-layer wiring pattern 37 is formed. Subsequently, the heater elements 39 are formed, then the insulating protective layer 40 and the second-layer wiring pattern 44 are formed, the heater elements 39 are connected to the transistors by the second-layer wiring pattern 44, and the wiring patterns 44 for the power supply, earth line and the like are formed. In the printer head 19, further, the insulating protective layer 45, the metal protective layer 46, the ink liquid chambers 52, and the nozzles 23 are sequentially formed (FIG. 6, FIGS. 7 to 11).

In the line printer 11, the inks retained in the head cartridge 18 are led through the ink passages 21 into the ink liquid chambers 52 of the printer head 19 formed in the above-mentioned manner (FIG. 5), the ink retained in the ink liquid chamber 52 is heated by driving the heater element 39 to generate a bubble, and the pressure inside the ink liquid chamber 52 is rapidly increased. In the line printer 11, the increase in the pressure causes the inks in the ink liquid chambers 52 to be jetted as ink droplets via the nozzles 23 provided on the heater elements 39, and the ink droplets are deposited on the paper 13 which is the object of printing fed from the paper tray 14 by the rollers 15, 16, 17 and the like.

In the line printer 11, the driving of the heater elements 39 is intermittently repeated, whereby a desired image or the like is printed on the paper 13, and the paper 13 is discharged through the discharge port (FIG. 4). In the printer head 19, by the intermittent driving of the heater elements 39, generation of bubbles and extinction of the bubbles are repeated in the ink liquid chambers 52, whereby cavitation as a mechanical shock is generated. In the printer head 19, the mechanical shock due to the cavitation is relaxed by the metal protective layer 46, so that the heater elements 39 are protected from the shock. In addition, the metal protective layer 46 and the insulating protective layer 40, 45 prevent the inks from making direct contact with the heater elements 39, which also protects the heater elements 39.

In the printer head 19, the second-layer wiring pattern 44 for connecting the transistors 34 concerning the driving of the heater elements 39 to the heater elements 39 is disposed on the ink liquid chamber 52 side of the heater elements 39, with the insulating protective layer 40 therebetween, and the metal wiring layer concerning the wiring pattern 44 is formed in a film thickness of 600 nm, which is not less than 400 nm. In the printer head 19, therefore, when the wiring pattern 44 is patterned by use of the dry etching step and the wet etching step according to the related art, the wall surfaces of the wiring pattern 44 are formed in a rugged shape, so that voids may be generated at the interface between the wiring pattern 44 and the insulating protective layer 45. Experimental results showed that when the wiring pattern material layer 43 formed by building up a 400 nm thick metal wiring layer or the like is patterned by the conventional technique, the wall surface portions are formed in a rugged shape.

In this embodiment, on the other hand, the wiring pattern 44 is formed by pattering using dry etching, and the wiring pattern 44 is connected to the heater elements 39 through the contact portions 41 formed by use of the openings provided in the insulating protective layer 40.

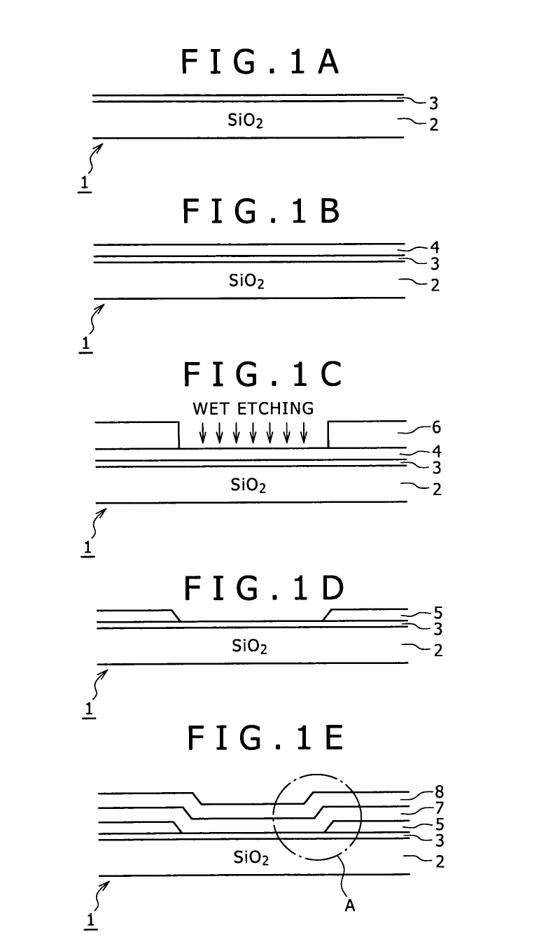

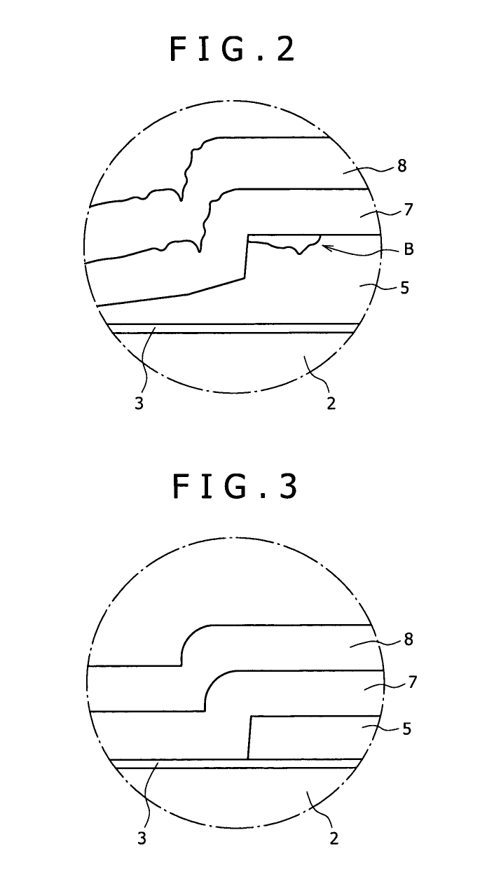

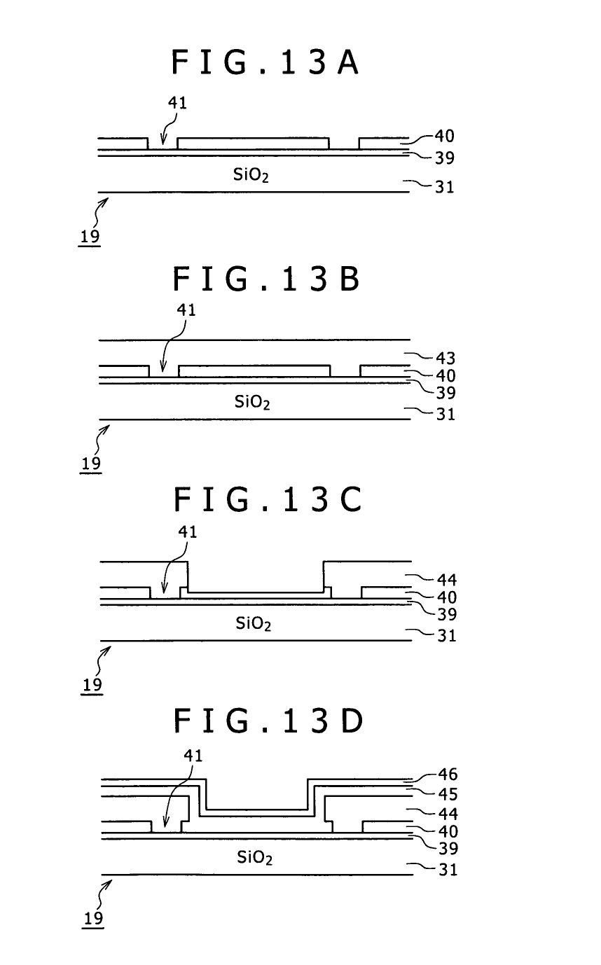

Specifically, as shown in FIGS. 13A to 13D in contrast to FIG. 1 which shows the technique of forming a wiring pattern according to the related art, in the printer head 19, the insulating protective layer 40 of silicon nitride is built up on the heater elements 39, thereafter the openings are formed in the insulation protective layer 40 and the contact portions 41 are provided there (FIG. 13A), and aluminum with silicon or copper added thereto or the like is built up thereon, to form the wiring pattern material layer 43 (FIG. 13B).

Subsequently, in the printer head 19, the surplus wiring pattern material layer 43 in the areas other than the areas on the heater elements 39 is etched by dry etching in which an etching gas containing a chlorine atom component is used. In the printer head 19, in this treatment, the wiring pattern material layer 43 in the areas on the heater elements 39 is also simultaneously etched and removed, but the insulating protective layer 40 previously formed on the heater elements 39 and served to the formation of the contact portions 41 is utilized as a mask for protecting the heater elements 39 against the dry etching, so that the heater elements 39 are prevented from being damaged (FIG. 13C). In the printer head 19, therefore, the wiring pattern 44 is accurately formed while preventing the heater elements 39 from being damaged by the etching gas, so the generation of voids at the interface between the wiring pattern 44 and the insulating protective layer 45 to be later formed thereon is obviated effectively.

In the printer head 19, the wiring pattern 44 formed in this manner is connected to the heater elements 39 through the contact portions 41, and, further, the insulating protective layer 45 and the metal protective layer 46 are sequentially formed (FIG. 13D).

In the printer head 19, the metal wiring layer concerning the second-layer wiring pattern 44 is formed in a film thickness of 600 nm, whereby weakening of the metal wiring layer itself can be prevented, and the parasitic resistance due to the metal wiring layer and the like can be reduced by about ⅔, as compared with the parasitic resistance above-mentioned referring to FIG. 3.

Besides, in the dry etching of the wiring pattern 44, the wiring pattern material layer 43 on the heater elements 39 is simultaneously removed by the dry etching step, whereby the number of steps can be reduced and the time required for the manufacture of the printer head 19 can be shortened, as compared with the related art.

In addition, in the dry etching of the wiring pattern 44, an over-etching is conducted by setting an etching time of about 1.2 times the etching time corresponding to the film thickness of the wiring pattern material layer 43, whereby the surplus wiring pattern material layer 43 can be securely removed, the short-circuiting between the wiring patterns due to the leaving of the wiring pattern material layer 43 can be prevented satisfactorily, and reliability can be secured accordingly.

Incidentally, the insulating protective layer 40, 45 and the metal protective layer 46 covering the heater elements 39 are formed in a total film thickness of not more than 700 nm, which ensures that in the printer head 19, the inks can be stably jetted out through the nozzles 23 with a sufficient margin in the case of driving the heater elements 39 by a rated driving power.

### (3) Effects of Embodiment

According to the above-mentioned configuration, the wiring pattern is formed by the patterning using the dry etching, and the wiring pattern is connected to the heater elements through the contact portions formed by use of the openings provided in the insulating protective layer, whereby it is possible to sufficiently secure the film thickness of the metal wiring layer concerning the wiring pattern and to reduce the parasitic resistance due to the metal wiring layer.

Specifically, the metal wiring layer concerning the wiring pattern is formed in a film thickness of not less than 400 nm, whereby weakening of the metal wiring layer itself can be prevented, and the resistance of the metal wiring layer can be prevented from being raised.

### (4) Embodiment 2

In this embodiment, an etching protective layer is formed on heater elements, and a layer thereon is provided with the contact portions above-mentioned in Embodiment 1. Incidentally, in this embodiment, a printer head is configured in the same manner as the printer head in Embodiment 1, except that the forming step concerning the etching protective layer is different; therefore, the same components as in Embodiment 1 will be denoted by symbols corresponding to those in Embodiment 1, and description thereof will be omitted.

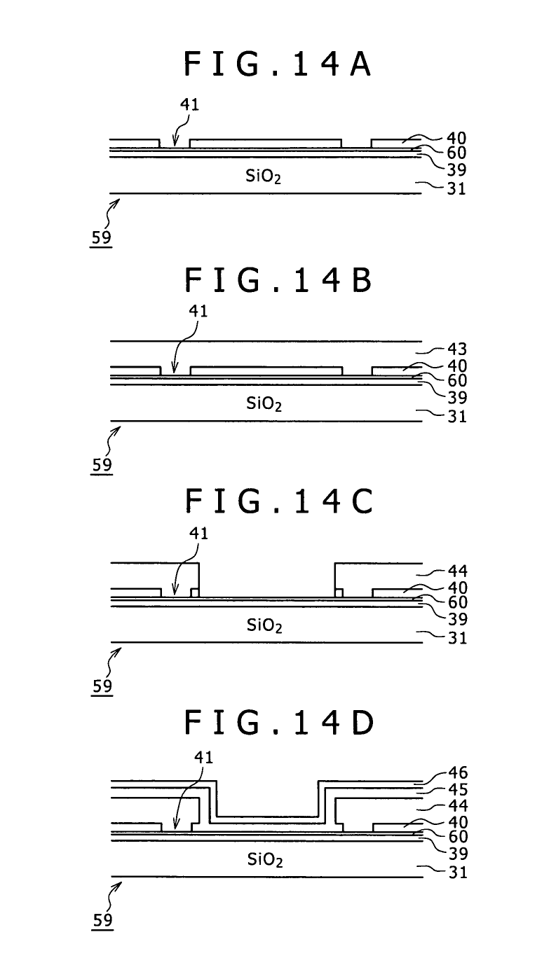

Specifically, as shown in FIG. 14A, in the printer head 59, the heater elements 39 are formed on a silicon substrate 31, and then the etching protective layer 60 is formed in a film thickness of 10 to 50 nm. Here, the etching protective layer 60 is a protective layer for protecting the heater elements 39 from the dry etching for a wiring pattern 44, and is formed of a material which is difficult to etch with the etching gas served to the patterning of the wiring pattern 44. Specifically, in this case, titanium oxynitride or tungsten is applied to the etching protective layer 60.

Specifically, in the case of a chloride of tungsten, the vapor pressure is high, so that tungsten is difficult to etch by the dry etching using an etching gas containing a chlorine atom component. In the case of titanium oxynitride, also, the etching rate with the etching gas containing the chlorine atom component is comparatively low, so that titanium oxynitride is difficult to etch by the dry etching using the etching gas containing the chlorine atom component. By this, in the printer head 59, even where an insulating protective layer 40 served to the formation of contact portions 41 is etched, the etching protective layer 60 is exposed, the etching protective layer 60 functions as a protective layer for the heater elements 39, and the heater elements 39 are protected against the dry etching of the wiring pattern 44.

Specifically, in the printer head 59, the insulating protective layer 40 is built up on the etching protective layer 60, and the insulating protective layer 40 is provided with openings, and the contact portions 41 are formed. Subsequently, as shown in FIG. 14B, the wiring pattern material layer 43 is formed. Then, the wiring pattern material layer 43 thus formed is selectively etched by the dry etching using an etching gas containing a chlorine atom component, whereby the wiring pattern 44 is patterned.

In the printer head 59, in the dry etching step, the wiring pattern material layer 43 on the heater elements 39 is simultaneously removed, and the insulating protective layer 40 served to the formation of the contact portions 41 is etched away, whereby the underlying etching protective layer 60 is exposed. Thus, in the printer head 59, the etching protective layer 60 functions as a mask for the heater elements 39, whereby the heater elements 39 can be prevented from being damaged by the dry etching.

Subsequently, in the printer head 59, as shown in FIG. 14D, an insulating protective layer 45 and a metal protective layer 46 are sequentially formed, and then nozzles 23, ink liquid chambers 52, ink passages 21 for leading inks into the ink liquid chambers 52 and the like are sequentially formed.

In this manner, the same effects as those of Embodiment 1 can be obtained even where an etching protective layer is separately formed on the heater elements, as in this embodiment. Specifically, since the etching protective layer is formed of a material which is difficult to etch by the etching gas served to the patterning of the wiring pattern, the heater elements can be securely protected against the dry etching even where the insulating protective layer served to the formation of the contact portions is removed by the dry etching of the wiring pattern.

### (5) Other Embodiments

While the case of forming an insulating protective layer from silicon nitride has been described in the above embodiments, the present invention is not limited to this case, and is widely applicable to other cases such as a case where the insulation protective layer is formed of silicon oxide instead of silicon nitride. In addition, in the printer head according to the above-described configuration, the insulating protective layer served to the formation of the contact portions and the insulating protective formed after the formation of the wiring pattern may be formed of different materials.

Besides, while the case of forming a metal wiring layer from aluminum with silicon or copper added thereto has been described in the above embodiments, the present invention is not limited to this case, and is widely applicable to other cases such as a case where the metal wiring layer is formed of aluminum, copper, tungsten or the like.

In addition, while the case of jetting out ink droplets by applying the present invention to a printer head has been described in the above embodiments, the present invention is not limited to this case, and is widely applicable to liquid jet heads wherein the liquid droplets are various dye droplets, protective layer forming droplets or the like in place of the ink droplets, micro-dispensers wherein liquid droplets are reagent droplets or the like, various measuring instruments, various testing equipments, various pattern drawing equipments wherein liquid droplets are chemical droplets for protecting members from etching, etc.

### INDUSTRIAL APPLICABILITY

The present invention relates to a liquid jet head, a liquid jet apparatus, and a method of manufacturing a liquid jet head, and is applicable, for example, to an ink jet printer based on the thermal system.

1. A liquid jet head comprising:
a heater element for heating a liquid retained in a liquid chamber; and
a semiconductor device for driving said heater element, said heater element and said semiconductor device being integrally held on a predetermined substrate, and a droplet of said liquid being jetted from a predetermined nozzle by driving said heater element,
wherein:
an insulating protective layer for protecting said heater element from said liquid and a metal wiring layer for connecting said semiconductor device to said heater element are sequentially disposed on said liquid chamber side of said heater element; and
said metal wiring layer is connected to said heater element through a contact portion formed by use of an opening provided in said insulating protective layer, and is formed through patterning which is caused by dry etching with an etching gas and is accompanied by removal of said metal wiring layer in thermal action portions due to the driving of said heater elements.

2. The liquid jet head as set forth in claim 1, wherein the film thickness of said metal wiring layer is set to be not less than 400 nm.

3. A liquid jet apparatus for jetting a droplet by driving a heater element provided in a liquid jet head, wherein:
said liquid jet head comprises
said heater element for heating a liquid retained in a liquid chamber, and
a semiconductor device for driving said heater element, said heater element and said semiconductor device being integrally held on a predetermined substrate;
an insulating protective layer for protecting said heater element from said liquid and a metal wiring layer for connecting said semiconductor device to said heater element are sequentially disposed on said liquid chamber side of said heater element; and
said metal wiring layer is connected to said heater element through a contact portion formed by use of an opening provided in said insulating protective layer, and is formed through patterning which is caused by dry etching with an etching gas and is accompanied by removal of said metal wiring layer in thermal action portions due to the driving of said heater elements.

4. A method of manufacturing a liquid jet head comprising:
a heater element for heating a liquid retained in a liquid chamber; and
a semiconductor device for driving said heater element, said heater element and said semiconductor device being integrally held on a predetermined substrate, and a droplet of said liquid being jetted from a predetermined nozzle by driving said heater element;
wherein:
an insulating protective layer for protecting said heater element from said liquid and a metal wiring layer for connecting said semiconductor device to said heater element are sequentially disposed on said liquid chamber side of said heater element; and
said metal wiring layer is connected to said heater element through a contact portion formed by use of an opening provided in said insulating protective layer, and is formed through patterning which is caused by dry etching with an etching gas and is accompanied by removal of the metal wiring layer in thermal action portions due to the driving of the heater elements.
